(19) United States
(12) Patent Application Publication
(10) Pub. No.: US 2026/0119199 A1
(43) Pub. Date: Apr. 30, 2026

(54) COMPUTER-IMPLEMENTED METHOD, SYSTEM AND COMPUTER PROGRAM PRODUCT FOR THE AUTOMATIC CONFIGURATION OF A SERVICE APPLICATION FOR GAS MEASURING DEVICES

(71) Applicant: Dräger Safety AG & Co. KGaA, Lübeck (DE)

(72) Inventors: Christof Rodehorst, Lübeck (DE); Mirko Haye, Lübeck (DE)

(21) Appl. No.: 19/047,078

(22) Filed: Feb. 6, 2025

(30) Foreign Application Priority Data
Feb. 9, 2024 (DE) 102024103717.2

(51) Int. Cl. G06F 9/445; G06F 21/31

(52) U.S. Cl. CPC G06F 9/44505; G06F 21/31

(57) ABSTRACT

The present disclosure relates to a computer-implemented method for the automatic configuration of a service application, wherein the service application is executed on a terminal and is suitable for servicing gas measuring devices. The method comprises the following steps: establishing a connection to a database, determining a decision criterion based on a login message, determining a selection list taking into account the decision criterion, wherein the selection list comprises at least a subset of data from the database, generating a piece of configuration information based on the selection list, executing the service application on the terminal with reference to the configuration information, and displaying the range of functions of the service application according to the configuration information. The disclosure further relates to a system for configuring a service application, which is suitable for carrying out such a method, as well as to a computer program product.

### CROSS-REFERENCE TO RELATED APPLICATIONS

This application claims the priority of German Patent Application No. 102024103717.2, filed on Feb. 9, 2024, and titled “COMPUTER-IMPLEMENTED METHOD, SYSTEM AND COMPUTER PROGRAM PRODUCT FOR THE AUTOMATIC CONFIGURATION OF A SERVICE APPLICATION FOR GAS MEASURING DEVICES”, which is hereby incorporated by reference in its entirety for all nonlimiting purposes.

### DESCRIPTION

The present disclosure relates to a computer-implemented method and to a system for the automatic configuration of a service application for gas measuring devices and to a computer program product which is suitable for carrying out the computer-implemented method.

Service applications for gas measuring devices are intended to support a user, in particular a service technician or a device technician, during maintenance, inspection, repair, testing and/or configuration of gas measuring devices. The service application offers a range of functions to enable the user to carry out these operations. Such a range of functions can include, for example, repair and/or diagnostic instructions, an option to communicate with a gas measuring device, configuration options as well as maintenance and/or inspection intervals for gas measuring devices. Typically, such a service application is provided by the manufacturer of the respective gas measuring devices, wherein the service application supports a plurality of the manufacturer's gas measuring devices. It is also conceivable for a service application to support a plurality of gas measuring devices from different manufacturers. Due to the plurality of gas measuring devices supported, a service application for gas measuring devices offers a very wide range of functions.

Such a service application is usually executed on portable or mobile terminals having a small display, such as smartphones or tablets, so that a user, for example a service technician, can use the terminal to service gas measuring devices at different locations. Furthermore, the service application is also executed on permanently installed processing units having a display, wherein such a processing unit is usually installed near several gas measuring devices so that the gas measuring devices can be serviced as easily as possible. Due to the very large range of functions of a service application, there is often the problem that the service application is confusing and difficult to use, in particular due to the limited display area of a small-format display. Furthermore, the problem may arise that a user cannot find a specific function among the plurality of functions in the very large range of functions of the service application and for this reason cannot carry out maintenance or must first spend a lot of time searching for these specific functions. From the perspective of an industrial plant operator, this problem can be significant, as service personnel may have to spend a lot of time finding the functions required for maintenance. This problem is multiplied for an operator of an industrial plant having a plurality of different gas measuring devices that are serviced by multiple users of the service application. The increased time expenditure directly results in increased operating costs for the maintenance of the gas measuring devices and may lead to a significant loss of production.

Solutions are known in the prior art, wherein users can configure the service application locally, for example on their tablet, and can thus limit the range of functions. The disadvantage is that the configuration is done manually and every user of the service application on a terminal has to perform this step manually, even if a majority of users require a service application with an identical, limited range of functions.

Furthermore, solutions are known in the prior art which use different service applications, each of which offers a specific, limited range of functions. These different service applications must then be installed on the terminal. It can be difficult for the user to keep track of everything, in particular when there are a plurality of different service applications. Furthermore, users must familiarize themselves with these different service applications and they must be individually adapted to the users'needs and kept up to date, which means an increased workload.

Based on the prior art and the problems described above, the object of the present disclosure is to provide a technical solution in which the presentation of the range of functions of the service application is clear and needs-based. The range of functions of the service application should be able to be automatically adapted to the users'needs.

The above object is achieved by a computer-implemented method for the automatic configuration of a service application for gas measuring devices on a terminal as described herein. Features and details which are described in connection with the computer-implemented method according to the disclosure also apply in connection with the system according to the disclosure and the computer program product according to the disclosure, so that with regard to the individual aspects of the disclosure, reference is always made or rather can be made to each other.

The disclosure relates to a computer-implemented method for the automatic configuration of a service application for gas measuring devices on a terminal. The computer-implemented method comprises the following steps:
Establishing a connection to a database;
determining a decision criterion based on a login message;
determining a selection list taking into account the decision criterion, wherein the selection list comprises at least a subset of data from the database;
generating a piece of configuration information based on the selection list;
executing the service application on the terminal with reference to the configuration information; and
displaying the range of functions of the service application according to the configuration information.

The decision criterion comprises at least one feature, in particular an attribute and a data field value of the database, for restricting and/or filtering a data volume of the database. The decision criterion comprises one or more features, wherein it is conceivable that several features are linked in order to limit and/or filter the data volume in the database.

The login message can be a digital message, a signal or a data set and comprises at least one piece of information from a login user at a terminal and/or at a central processing unit. The login message contains information about and/or from the login user. For example, the login message can include an identifier and/or properties of a user of the service application, location information, properties of a user's work environment and/or input information of the login user. The login user can be a person, for example the user of the terminal or service application, or another processing unit, wherein the other processing unit is connected to the terminal and/or central processing unit for data exchange.

The range of functions is understood to mean the entirety of the functions currently available in the service application that enable and/or support a user in performing a specific operation, in particular maintenance and/or repair, in relation to a gas measuring device. The functions relate to one or more gas measuring devices and are available to the user of the service application, wherein the user can select one or more functions to perform the specific operation. The one or more gas measuring devices can be mobile, i.e., portable, and/or stationary gas measuring devices. Furthermore, the functions are available directly within the service application or via a menu in the service application.

As previously described, the terminal can be a stationary or, in some examples, mobile terminal, wherein the terminal executes the service application and has a display to show the range of functions of the service application. Without the proposed computer-implemented method, the range of functions of the service application is usually very large, wherein all functions of the service application are shown on the display, i.e., a complete range of functions with all functions that the service application offers upon installation on the terminal.

The computer-implemented method according to the disclosure can be carried out either only on the terminal or partly on a central processing unit and partly on the terminal. The central processing unit, for example a server or a computer in a control room of an industrial plant, is located remotely from the terminal and can be wirelessly connected to the terminal via an interface for data exchange. The two scenarios are briefly explained below. A detailed description of the individual steps of the computer-implemented method is given thereafter.

The method can be carried out on the terminal. To this end, the terminal connects to the database, for example when switched on, and determines, on the basis of the login message, for example login data of the user of the terminal, the decision criterion for determining the selection list, wherein the decision criterion can comprise one or more features. The decision criterion comprises several features in particular if the login message comprises several pieces of information. For example, the login data are assigned to a qualification profile of the user, for example of a service technician, in the database, so that by means of this decision criterion those gas measuring device types that are covered by the user's qualification profile are determined from the database and added to the selection list. These are the types of gas measuring devices for which the user is permitted to carry out maintenance in accordance with their qualification profile. The assignment of the qualification profile to the gas measuring device types is stored in the database. This means that corresponding gas measuring device types are determined and a piece of configuration information is created based on the selection list with the gas measuring device types, which restricts the range of functions of the service application to these gas measuring device types.

In some examples, the method can be carried out partly on a central processing unit and partly on the terminal. The central processing unit, for example a computer in a control room, connects to the database and determines the decision criterion based on the login message. The login message comprises, for example, location information. The location information refers to a location where gas measuring devices monitored by the control room are to be serviced, for example. Using the decision criterion, i.e., the location of gas measuring devices to be serviced, those gas measuring devices from the database to which this location is also assigned in the database are identified and added to the selection list. Using this selection list, i.e., a list of the selected gas measuring devices, configuration information is created and transmitted to the terminal. The service application on the terminal takes this configuration information into account and displays the range of functions that is limited according to the configuration information, i.e., only those functions of the service application that are necessary for servicing the previously identified gas measuring devices.

In one step of the computer-implemented method, the connection to the database is established, wherein the database comprises a single database or multiple databases. The database may include information on gas measuring devices, maintenance dates, manpower planning, login users and/or the terminal as well as at least a partial allocation of the various pieces of information to one another.

Information on gas measuring devices may include master data of the gas measuring devices, such as a device identification (device ID), a device type, an installation site and/or a company affiliation, wherein company affiliation assigns for example a device ID to the name of a company. Additional pieces of information characterizing a gas measuring device or comprising properties of the gas measuring device are also conceivable.

Information on maintenance dates may include due dates and/or maintenance intervals for gas measuring devices. In some examples, maintenance due dates are available for at least a plurality of gas measuring devices so that it can be determined when each gas measuring device should be serviced.

Manpower planning information may include an identification of a user of the service application, a service location, a service time and/or at least one device ID. For example, a specific service technician is assigned a service time and several device IDs, wherein certain gas measuring devices are to be serviced during the service time.

Information about the login user may include a name, an identifier, a qualification profile, a company affiliation and/or a location. Additional pieces of information characterizing a login user or comprising properties of the login user are also conceivable.

Information about the terminal may include a display size, a display resolution and/or a location of use of the terminal. Additional pieces of information characterizing a terminal or comprising properties of the terminal are also conceivable.

In some examples, the information in the database is at least partially associated with one another. In particular, device IDs, i.e., a unique identifier of a gas measuring device, are linked to the various information in the database. Advantageously, it is thus possible to determine relevant information, in particular for a specific gas measuring device or a plurality of specific gas measuring devices.

In a further step of the computer-implemented method, the decision criterion is determined based on the login message. The login message may comprise information about a login user at the central processing unit or a login user at the terminal, such as login data of a login user. Further, the login message alternatively or additionally comprises input information specified by the login user, such as location information. The determined decision criterion can comprise a single or a plurality of features or criteria, wherein the single criterion or the plurality of criteria corresponds at least in derived form to the piece or pieces of information of the login message and the decision criterion can be assigned to at least one data set of the database.

In a next step of the computer-implemented method, the selection list is automatically determined taking into account the decision criterion. The selection list contains a single or a plurality of database entries. According to the decision criterion, database entries are thus selected or filtered from the database. For example, the decision criterion includes location information, wherein those device IDs to which a corresponding location is assigned in the database are determined from the database and added to the selection list. These are the gas measuring devices the installation location of which corresponds to the location specified. The selection list accordingly includes the determined device IDs. It is also conceivable for the selection list to additionally or alternatively include the device types that are assigned to the device IDs in the database.

In a further step of the computer-implemented method, the configuration information is generated according to the selection list. It is also conceivable that already existing configuration information is selected based on the selection list. That existing configuration information is selected the content of which includes at least the content of the selection list. In some examples, the configuration information is a file or a comparable data product that can be processed or used by the service application. It is also conceivable for the configuration information to be a digital message that can be received by the terminal and interpreted by the service application. The configuration information serves as a display rule for the service application and determines its range of functions. For example, the configuration information includes an identifier of those gas measuring device types that were previously identified.

In a next step of the computer-implemented method, the configuration information is read in and applied by the service application, wherein the range of functions is displayed and, in particular, restricted according to the configuration information. For example, only the functions that are relevant for previously identified gas measuring device types are made available and displayed in the service application.

Advantageously, users of the service application can be presented with a range of functions adapted to their needs, so that they have an improved overview of the functions of the service application and can use them efficiently when servicing gas measuring devices.

According to an exemplary embodiment of the computer-implemented method according to the disclosure, the login message is generated by the terminal. The login message includes information relating to the corresponding terminal and/or to a user using the terminal and the service application. Advantageously, it is thus possible to configure the service application individually to suit the terminal and/or the user. Furthermore, the user, for example a service technician, has the option of influencing the range of functions displayed in the service application by, for example, adding location information and/or a device type to the login message.

In an exemplary embodiment of the computer-implemented method, the login message is generated by a central processing unit. The login message comprises a piece of information relating to the central processing unit, for example location information, and/or specific information of a user operating the central processing unit. The central processing unit is connected, via an interface for data exchange, to the database and to at least one terminal that is capable of executing the service application.

According to an exemplary embodiment of the computer-implemented method, a terminal list with terminal identifiers is created and the configuration information is transmitted to the terminals according to the terminal list. The terminal identifier includes a unique identification or identifier of a respective terminal.

After at least one piece of configuration information has been generated, the central processing unit may check whether and which other terminals are also suitable for using the generated configuration information and should display the range of functions of the service application in accordance with this configuration information. In some examples, information about the available terminals is stored in the database. The central processing unit now selects those terminals having the same or at least similar properties as the terminal for which the configuration information was generated. In some examples, the locations and/or the display sizes assigned to the terminals are compared with each other. If the properties are substantially the same, the terminal identifier of the respective terminal is added to the terminal list. The generated configuration information is then transmitted wirelessly, for example via an interface, from the central processing unit to the terminals according to the terminal list. It is also conceivable for the generated configuration information to be transmitted wirelessly, via an interface, from the terminal for which the configuration information was generated to the other terminals in accordance with the terminal list.

Advantageously, the generated configuration information is transmitted to at least one further terminal, if the latter is suitable. The configuration information is thus reused and does not have to be generated again for each individual terminal.

In an exemplary embodiment of the computer-implemented method, the selection list comprises a list of device identifications (device IDs) for gas measuring devices, wherein the list of device identifications is created on the basis of the decision criterion comprising a determined operating location and/or a determined company designation. It is conceivable for the list to comprise a single device ID or a multitude of device IDs. In this exemplary embodiment variant, the range of functions of the service application is thus adapted to a selection of gas measuring devices or gas measuring device types. The operating location and/or the company designation can be determined on the basis of the login message. In some examples, the login message contains information relating to a login user who is assigned to an operating location and/or a company designation in the database. Furthermore, the operating location and/or the company designation are assigned to one or more device IDs in the database, so that the corresponding device IDs are added to the selection list. It is also conceivable for the gas measuring device types assigned to the device IDs to be added to the selection list. Based on the selection list, the configuration information which is applied by the service application on the respective terminal is then generated.

Advantageously, the range of functions of the service application is restricted to relevant gas measuring devices or gas measuring device types, taking into account the operating location and/or the company designation.

According to an exemplary embodiment of the computer-implemented method, the selection list comprises a list of upcoming events, wherein the list of upcoming events is created based on a comparison of the current time and a respective due time of the events. It is conceivable for the list to comprise a single event or a multitude of events. The upcoming events are those events the due date of which has been reached or is in the near future, for example a few days to a few weeks.

Events are understood to mean the names of actions that can be carried out on or with a gas measuring device. This includes, for example, a software update, a configuration, a test, a calibration, a component replacement and/or an adjustment of a gas measuring device. In some cases, such events must be carried out periodically, such as adjusting the sensors of a gas measuring device.

In this exemplary embodiment, the range of functions of the service application is thus adapted to a selection of such events and restricted to these events or to the gas measuring devices assigned to the events. The decision criterion for determining the selection list may include current time information, which may be/include a date. Using this time information, upcoming events and/or device IDs associated with the upcoming events are determined from the database and configuration information is generated. The range of functions of the service application is restricted by means of the configuration information in such a way that the upcoming events and/or the respective gas measuring devices for which an event is pending are displayed. Advantageously, based on said limited range of functions, the user of the service application immediately sees which operations must be performed on which gas measuring device.

In an exemplary embodiment of the computer-implemented method, a property of the terminal is read from the database and/or from the terminal and taken into account when generating the configuration information. The property of the terminal may include the dimensions and/or the resolution of a display of the terminal.

In this exemplary embodiment, the configuration information is supplemented by a piece of display information related to the properties of the terminal. The display information specifies how the range of functions should be displayed on the display of the terminal. For example, if the range of functions according to the previously generated configuration information is small and the display is small, for example on a smartphone, the display information indicates that the range of functions is shown entirely on the display. For example, if the range of functions according to the configuration information is large and the display is small, the display information indicates, for example, that only part of the range of functions is shown on the display, while another, remaining part of the range of functions can be displayed by moving the display section and/or within a menu or submenu.

Advantageously, in this embodiment of the computer-implemented method, the display properties of the terminal are also taken into account in addition to the range of functions. This enables flexible use of different terminals with differently designed displays.

According to an exemplary embodiment of the computer-implemented method, the generated configuration information is supplemented and/or modified by a piece of input information. The input information is generated by a person or by another processing unit that is connected to the terminal or the central processing unit for data exchange. The input information includes, for example, gas measuring device types that are added, removed or replaced in the configuration information. The method advantageously offers the possibility of making additional changes so that the range of functions can be individually adapted.

The disclosure further relates to a system for configuring a service application for gas measuring devices comprising a terminal, a central processing unit and a database, wherein the terminal has a display. The terminal is configured to execute the service application and display its range of functions on the display. The terminal is further configured to communicate with the central processing unit, wherein the central processing unit has access to the database. The system according to the disclosure is characterized in that the central processing unit and/or the terminal is configured to establish a connection to the database, to determine a decision criterion on the basis of a piece of login information, to determine a selection list taking into account the decision criterion, wherein the selection list comprises at least a subset of data from the database, and to generate a piece of configuration information on the basis of the selection list. The terminal is further configured to execute the service application with reference to the configuration information and, in particular, to restrict the range of functions of the service application according to the configuration information and to display it on the display.

The database has one or more databases and includes in particular information on gas measuring devices, maintenance dates, manpower planning, login users and/or the terminal as well as at least a partial allocation of the various pieces of information to one another. The central processing unit has direct access to the information in the database. The terminal has indirect access to the information in the database via the central processing unit.

In some examples, the terminal is configured to carry out the steps described below. In some examples, the central processing unit and the terminal are configured to communicate with each other and to at least partially carry out the steps described below, wherein each step is carried out either by the central processing unit or by the terminal.

The central processing unit and/or the terminal is configured to establish a connection to the database in one step, for example after switching on the terminal or the central processing unit. The connection to the database may be established after receipt of the login message. The login message includes information about and/or from a login user. The decision criterion can be determined in a further step on the basis of this login message, wherein the decision criterion comprises at least one feature, in particular an attribute and a data field value of the database, for restricting and/or filtering a data volume of the database. The login message information is related to at least one database entry so that a decision criterion can be determined. The decision criterion can be used to determine the selection list for generating the configuration information. Data from the database is filtered using the decision criterion, for example a piece of location information, and added to the selection list. This data may include, for example, device IDs or a specific identifier for a particular gas measuring device type. The configuration information generated on the basis of the selection list is taken into account when the service application is executed on the terminal and a limited range of functions is displayed, which, for example, only includes relevant functions for the previously determined device IDs or device types. If necessary, in particular in the case where the central processing unit generates the configuration information, the central processing unit is further configured to transmit the configuration information to the terminal.

Advantageously, the system according to the disclosure offers a user of the service application a needs-based range of functions of the service application as well as a clear presentation of relevant functions.

The disclosure further relates to a computer program product comprising instructions which, when executed by a processing unit, cause the processing unit to execute the computer-implemented method according to the disclosure and/or one of the previously described embodiments of the computer-implemented method. The processing unit comprises a computer, a processor and/or a programmable hardware component. In some examples, the central processing unit described above or the terminal described above comprises the processing unit. In some examples, the processing unit comprises several processing units, wherein the central processing unit and the terminal each have at least one of these several processing units, so that the computer-implemented method can be executed partly on the central processing unit and partly on the terminal.

Further features, objects and effects of the disclosure will become apparent from the following description of specific exemplary embodiments and from the accompanying figures. Exemplary embodiments of the disclosure are described without limiting the general inventive concept.

In the figures:

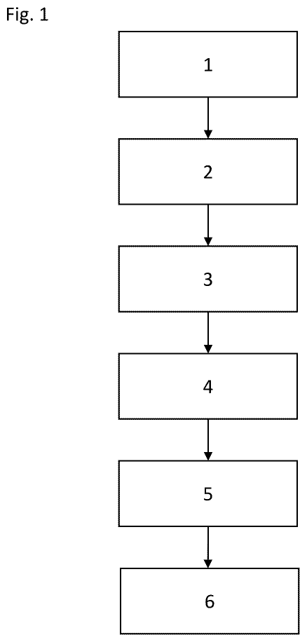

FIG. 1 shows a flow chart of an embodiment of the computer-implemented method according to the disclosure;

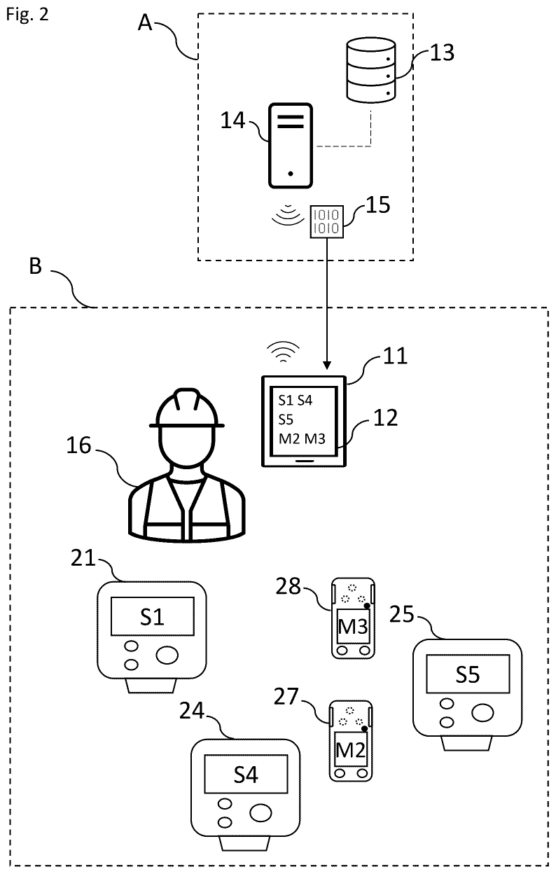

FIG. 2 shows a schematic representation of an embodiment of a system for configuring a service application, wherein the service application is restricted to available gas measuring devices; and

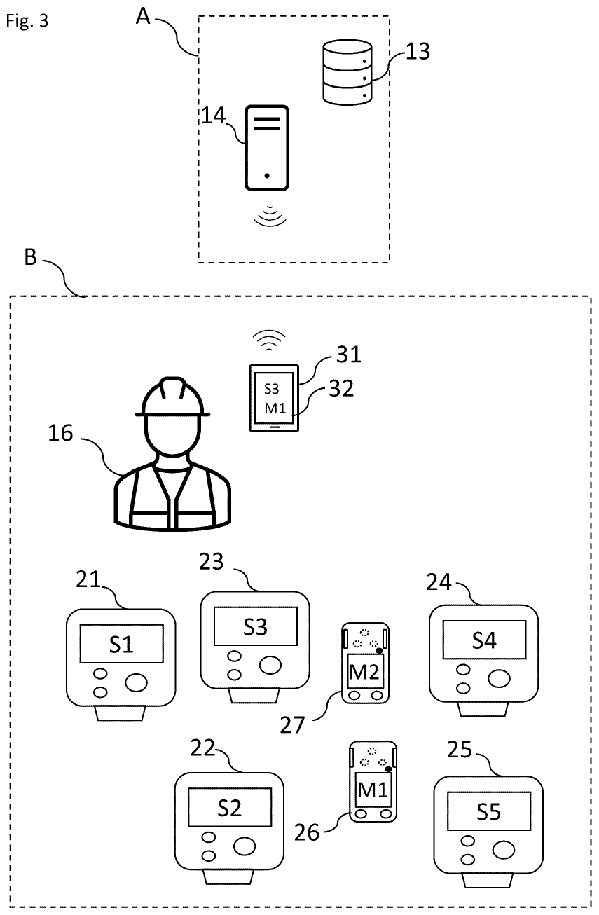

FIG. 3 shows a schematic representation of an embodiment of a system for configuring a service application, wherein the service application is restricted to gas measuring devices due for maintenance.

Exemplary embodiments of the invention are described in detail below with reference to the accompanying figures. Similar components in multiple figures are each provided with the same reference symbols.

FIG. 1 schematically shows a flow chart of an exemplary embodiment of the computer-implemented method according to the disclosure, wherein the method is carried out partly by a central processing unit 14 and partly by a terminal 11, 31 as illustrated in FIGS. 2-3. In a first method step 1, the central processing unit 14, in this case a computer in a control room, connects to a database 13 after a device technician (not shown) has logged into the central processing unit 14. The database 13 includes, among other things, data from gas measuring devices, in particular their device ID, their maintenance dates and their location.

In a second method step 2, the central processing unit 14 determines a decision criterion based on a login message. The login message includes a piece of location information entered by the device technician at the central processing unit 14. Alternatively, the device technician may select a piece of location information from a predefined list of location information. Also or alternatively, the device technician may enter login data, i.e., an identifier for identifying the device technician, into the central processing unit and the central processing unit 14 uses this login data to determine a piece of location information from the database, wherein the database includes the login data and a piece of location information associated with the login data. In the three variants mentioned above, the decision criterion determined is a piece of location information, which leads to a restriction of the range of functions of the service application in the further course of the method.

In a third method step 3, the central processing unit 14 determines a selection list taking into account the decision criterion. The central processing unit 14 adds to the selection list all device IDs of gas measuring devices from the database 13 the location of which corresponds to the piece of location information.

In a fourth method step 4, the central processing unit generates a piece of configuration information 15 based on the selection list. During this process, a piece of configuration information 15 is generated in the form of a file which includes information on the gas measuring devices, in particular the device IDs, according to the selection list and is suitable for being read in or used by a service application for gas measuring devices. The format of the file is, for example, JSON (JavaScript Object Notation), and the service application on the terminal is configured to interpret this format and read the device IDs. The piece of configuration information 15 is transmitted wirelessly, via an interface, from the central processing unit to the terminal 11, 31 on which the service application is installed. It is conceivable for the central processing unit 14 to transmit the generated configuration information 15 to all terminals 11, 31 connected to the central processing unit 14 or to a selection of terminals 11, 31. The selection of terminals 11, 31 can be specified by the login user by means of an entry and in the form of the login message, or can be taken into account when determining the selection list. In the latter case, the database additionally includes identifiers of the respective terminals 11, 31 and a location associated therewith, so that according to the piece of location information, in addition to the device IDs, the identifiers of the terminals 11, 31 the location of which corresponds to the piece of location information are added.

In a fifth method step 5, the service application is executed on the terminal 11, 31 with reference to the piece of configuration information 15. The service application reads the configuration information 15 previously received by the terminal 11, 31 and interprets its content, in this case the device IDs. Using the device IDs, the service application filters out those functions from its full range of functions that are necessary for the repair and/or maintenance of the device IDs.

In a sixth method step 6, the range of functions of the service application is displayed on a display 12, 32 of the terminal 11, 31 according to the piece of configuration information 15 and the filtered functions. The range of functions is limited to those functions of the service application that are assigned to the previously determined device IDs.

Advantageously, this method limits the range of functions of the service application to what is essential, namely to the functions that are suitable for repairing and/or maintaining gas measuring devices at a specific location. This reduces the range of functions and thus the content of the service application to be displayed, so that the essential functions are presented clearly. This limited range of functions makes it easier for the service technician to operate the service application and thus also to repair and/or service the gas measuring devices.

FIG. 2 shows a schematic representation of an embodiment of a system for configuring a service application, wherein the range of functions of the service application in this case is restricted to available gas measuring devices 21, 24, 25, 27, 28 of an industrial plant in a second environment B.

The system according to FIG. 2 comprises a central processing unit 14 which is connected to a database 13 and is located in a first environment A. In this exemplary embodiment, the central processing unit is a computer in a control room for an industrial plant in a second environment B. In the second environment B, i.e., the industrial plant, several stationary and mobile gas measuring devices 21, 24, 25, 27, 28 are in use. These gas measuring devices 21, 24, 25, 27, 28 must be serviced by a service technician 16. For this purpose, the service technician 16 uses a terminal device, for example a tablet 11, on which the service application is installed. The range of functions of the service application initially includes functions for servicing the gas measuring devices 21, 24, 25, 27, 28 and other types of gas measuring devices 22, 23, 26 that are not used in the second environment B. The tablet 11 is wirelessly connected to the central processing unit 14 via an interface.

To create a piece of configuration information 15 for the service application on the tablet 11, a device technician (not shown) first logs into the central processing unit 14. To do so, the device technician uses in particular a login name. A login message is generated which includes the login name, whereupon the central processing unit 14 connects to the database 13 and reads out, as a decision criterion, a piece of location information associated with the login name of the device technician. In this exemplary embodiment, the piece of location information includes a designation for the second environment B, i.e., the industrial plant. This piece of location information is used by the central processing unit to determine device IDs of gas measuring devices 21, 24, 25, 27, 28 from the database. Those device IDs to which a location is assigned according to the location information are added to a selection list, i.e., the gas measuring devices 21, 24, 25, 27, 28 that are used on the industrial plant in the second environment B. The central processing unit then generates the piece of configuration information 15, which is a file containing the device IDs of the selection list.

The piece of configuration information 15 is transmitted from the central processing unit to the tablet 11 via the interface. The service application is executed on the tablet 11, reads in the piece of configuration information 15 and displays a limited range of functions on the tablet display 12. The range of functions is limited such that only functions that are required for servicing the previously identified gas measuring devices 21, 24, 25, 27, 28 are displayed. In FIG. 2, this is indicated by identifiers S1, S4, S5, M2, M3 of the gas measuring devices 21, 24, 25, 27, 28, which are visible on the tablet display 12 after application of the configuration information 15 by the service application. Functions that refer to other gas measuring devices 22, 23, 26 with identifiers S2, S3, M1 are not shown on the tablet display 12 by the service application because they are not used in the second environment B.

FIG. 3 shows a schematic representation of an embodiment of a system for configuring a service application, wherein the range of functions of the service application is restricted to gas measuring devices 23, 26 due for maintenance.

The system according to FIG. 3 comprises a central processing unit 14 which is connected to a database 13 and is located in a first environment A. In this exemplary embodiment, the central processing unit 14 is a computer, in particular a server, of a control room for an industrial plant in a third environment C. In the third environment C, i.e., the industrial plant, several stationary and mobile gas measuring devices 21, 22, 23, 24, 25, 26, 27 are in use, wherein the third stationary gas measuring device 23 with identifier S3 and the first mobile gas measuring device 26 with identifier M1 are due for maintenance. The maintenance intervals for the third stationary and the first mobile gas measuring device 23, 26 have thus already expired. These two gas measuring devices 23, 26 must be serviced by a service technician 16. For this purpose, the service technician 16 uses a terminal device, such as a smartphone 31, on which the service application is installed. The range of functions of the service application initially includes functions for servicing the gas measuring devices 21, 22, 23, 24, 25, 26, 27 and other types of gas measuring devices that are not used in the third environment C. The smartphone 31 is wirelessly connected to the central processing unit 14 via an interface.

First, the smartphone 31 connects to the database 13 via the interface and the central processing unit 14. The service technician indicates on smartphone 31 that they would like to use the service application to maintain those gas measuring devices 21, 22, 23, 24, 25, 26, 27 that are due for maintenance. This piece of information is included in a login message, for example in the form of a request, and is used to determine a decision criterion on the smartphone 31. The current date is assigned to the decision criterion. The smartphone 31 then adds to a selection list those device IDs of gas measuring devices 21, 22, 23, 24, 25, 26, 27 the maintenance interval of which has expired. The smartphone 31 reads the dates for maintenance of the gas measuring devices 21, 22, 23, 24, 25, 26, 27 from the database 13 and compares them with the current date. If the date for maintenance of the respective gas measuring device 21, 22, 23, 24, 25, 26, 27 is in the past, the smartphone 31 adds its device ID to the selection list, i.e., in that case, the device ID of the third stationary and first mobile gas measuring device 23, 26. The smartphone then generates a piece of configuration information that includes the device IDs in the selection list and which is read by the service application. The service application then only displays functions for the maintenance of the third stationary and first mobile gas measuring device 23, 26 on the smartphone display 32. In FIG. 3, this is indicated by identifiers S3 and M1 in the smartphone display 32. Thus, the range of functions of the service application is limited to what is essential with respect to the original range of functions, whereby a clear presentation on the smartphone display 32 is achieved and the service technician can carry out their operations efficiently.

### List of Reference Signs

1 First method step
2 Second method step
3 Third method step
4 Fourth method step
5 Fifth method step
6 Sixth method step
11 Tablet with installed service application
12 Tablet display
13 Database
14 Central processing unit
15 Piece of configuration information
16 Service technician
21 First stationary gas measuring device
22 Second stationary gas measuring device
23 Third stationary gas measuring device
24 Fourth stationary gas measuring device
25 Fifth stationary gas measuring device
26 First mobile gas measuring device
27 Second mobile gas measuring device
28 Third mobile gas measuring device
31 Smartphone with installed service application
32 Smartphone display
A First environment
B Second environment
C Third environment

1-10. (canceled)

11. A method for automatically configuring a service application for gas measuring devices on a terminal device, comprising:
establishing a connection between the terminal device and a computing device;
establishing a connection to a database;
determining a decision criterion;
determining a selection list based on the decision criterion, wherein the selection list comprises at least a subset of data from the database;
generating configuration information based on the selection list;
executing the service application on the terminal device based on the configuration information; and
displaying, based on the configuration information, a range of functions of the service application.

12. The method of claim 11, further comprising:
receiving a login message, wherein the determining the decision criterion is based on the login message and wherein the login message is generated by:
the terminal device; or
the computing device.

13. The method of claim 11, further comprising sending the configuration information.

14. The method of claim 11, further comprising:
generating a terminal device list comprising one or more terminal device identifiers; and
sending, based on the terminal device list, the configuration information to one or more additional terminal devices.

15. The method of claim 11, wherein the selection list comprises a list of device identifiers for gas measuring devices, wherein the list of device identifiers is based on one or more of:
a determined operating location of one or more gas measuring devices; or
a determined company designation of one or more gas measuring devices.

16. The method of claim 11, wherein the selection list comprises a list of events, wherein the list of events is based on a comparison of a current time and a respective due time of each event of the list of events.

17. The method of claim 11, wherein generating the configuration comprises:
receiving a property of the terminal device from one or more of:
the database; or
the terminal device; and
wherein the property of the terminal device comprises one or more of:
a dimension of a display of the terminal device; or
a resolution of the display of the terminal device.

18. The method of claim 11, further comprising:
modifying the configuration information based on input information received after a login message.

19. The method of claim 11, wherein determining the selection list comprises:
retrieving, from the database and based on the decision criterion, a user profile;
identifying, based on the user profile, one or more gas measuring device types; and
selecting the range of functions of the service application, wherein selecting the range of functions comprises excluding, from a plurality of candidate functions of the service application, one or more functions corresponding to gas measuring device types different from the one or more gas measuring device types.

20. The method of claim 11, wherein the terminal device comprises a mobile device and wherein the method further comprises receiving a location of the mobile device.

21. A system for automatically configuring a service application for gas measuring devices, the system comprising:
a terminal device comprising:
a display; and
first memory storing first instructions; and
a computing device comprising:
a database configured to store data; and
second memory storing second instructions;
wherein, when executed, at least one of the first instructions or the second instructions cause:
establishing a connection between the terminal device and the computing device;
establishing a connection to the database;
determining a decision criterion;
determining a selection list based on the decision criterion,
wherein the selection list comprises at least a subset of data from the database;
generating configuration information based on the selection list;
executing the service application on the terminal device based on the configuration information; and
displaying, based on the configuration information, a range of functions of the service application.

22. The system of claim 21, wherein, when executed, at least one of the first instructions or the second instructions further cause generating a login message, wherein the determining the decision criterion is based on the login message.

23. The system of claim 21, wherein, when executed, at least one of the first instructions or the second instructions further cause sending the configuration information.

24. The system of claim 21, wherein, when executed, the at least one of the first instructions or the second instructions, further cause:
generating a terminal device list comprising one or more terminal device identifiers; and
sending, based on the terminal device list, the configuration information to one or more additional terminal devices.

25. The system of claim 21, wherein the selection list comprises a list of device identifiers for gas measuring devices, wherein the list of device identifiers is based on one or more of:
a determined operating location of one or more gas measuring devices; or
a determined company designation of one or more gas measuring devices.

26. A computer program product, embodied on a non-transitory machine-readable medium, comprising instructions which, when executed by a processing unit, cause:
establishing a connection between a terminal device and a computing device;
establishing a connection with a database;
determining a decision criterion;
determining a selection list based on the decision criterion, wherein the selection list comprises at least a subset of data from the database;
generating configuration information based on the selection list;
causing, based on sending the configuration information, execution of a service application for gas measuring devices; and
causing, based on sending the configuration information, display of a range of functions of the service application.

27. The computer program product of claim 26, wherein the instructions, when executed by the processing unit, further cause:
generating a login message, wherein the determining the decision criterion is based on the login message and wherein the login message is generated by:
the terminal device; or
the computing device.

28. The computer program product of claim 26, wherein the instructions, when executed by the processing unit, further cause sending the configuration information.

29. The computer program product of claim 26, wherein the instructions, when executed by the processing unit, further cause:
generating a terminal device list comprising one or more terminal device identifiers; and
sending, based on the terminal device list, the configuration information to one or more additional terminal devices.

30. The computer program product of claim 26, wherein the selection list comprises a list of device identifiers for gas measuring devices, wherein the list of device identifiers is based on one or more of:
a determined operating location of one or more gas measuring devices; or
a determined company designation of one or more gas measuring devices.
